(19) United States
(12) Patent Application Publication
(10) Pub. No.: US 2003/0140306 A1
(43) Pub. Date: Jul. 24, 2003

(54) System and method for remotely entering and verifying data capture

(76) Inventor: Robert J. Robinson, Camp Hill, PA (US)

Correspondence Address: Reed Smith Shaw & McClay, LLP, 213 Market Street/ 9th Floor, P.O. Box 11844, Harrisburg, PA, 17108-1844, US

(21) Appl. No.: 10/050,981

(22) Filed: Jan. 18, 2002

(51) Int. Cl. G06F 15/00

(52) U.S. Cl. 715/500

(57) ABSTRACT

A system for remote data entry and verifying the accuracy of data entry is disclosed. The invention comprises a system and method for inputting information from a form or other source, defining a plurality of data fields in the form to be entered and verified such that each data field defines and corresponds to at least one unique data entry; dividing each unique data entry into snippets of information, scrambling the snippets to ensure confidentiality and security; transmitting the scrambled snippets to remote end users for data entry and verification; receiving back entered and verified data entry from remote end users, and accepting the data entry as accurate if two or more end users or other data entry sources enter and verify the data identically.

### FIELD OF THE INVENTION

The present invention is directed to online computer systems. In particular, the present invention is directed to the field of online data capture, data entry, and verification, and in particular, to remote and distributed data capture, data entry, and data verification for documents and forms containing confidential information, such as tax forms, credit card applications, loan applications, membership applications, medical claim forms, and the like.

### BACKGROUND OF THE INVENTION

The Internet or World Wide Web is one of the most critical technological developments of the late 20^{th} Century. The Internet has provided vast economic opportunities for numerous businesses and industries to vastly expand the number, quality and manner of their services. One of the earliest and fastest growing areas of Internet activity has been in providing rapid, up-to-the-minute business information. To date, a large number of patents have issued on Internet related systems that cover a wide array of business information and electronic commerce (e-commerce) applications.

Traditional Data Entry

Historically, the problem of data capture, data entry, and data verification has been a difficult and time-consuming task. Data entry has been used since the inception of computers for the purpose of transferring information that exists outside the computer into the computer for processing. The procedure of capturing information on paper forms and transferring it into an electronic format is known as data capture. The key to efficient data capture is to maximize user reading and keying speeds while minimizing reading and keying errors. While the process of data capture would appear to be a straightforward process, rarely is it a core competency of government agencies, credit card bureaus and other organizations that must process large quantities of hand written or machine printed data forms in order to accomplish their business objectives. Hence, data capture remains a problematic and expensive endeavor for governments and businesses.

There are three primary methods of data capture utilized today: 1) key-from-paper (KFP); 2) key-from-image (KFI); and, 3) the use of computer-enabled recognition technologies. Using the key-from-paper method of data capture, necessary information is typed directly into the computer by a data entry operator. This is the oldest and most traditional method of data capture. Usually, a data entry operator has the physical paper forms and is presented with a graphic user interface (“GUI”) providing an electronic form with fields that the data is keyed into. The data entry operator tabs or is led from field to field and keys data in each field until the form is completely entered. Although dedicated data entry operators can approach 20,000 keystrokes per hour, key-from-paper remains a very labor-intensive process. Because operators must continually look to the paper form, and back to the computer screen, most operators achieve much less than the ideal keying rate.

Using the key-from-image method of data capture, the original paper document is scanned into the computer and saved as an electronic image. Although humans can read the data present in the displayed image, the computer cannot process the data until it is captured in a computer-usable format. Therefore, the data entry operator is provided with a GUI displaying the electronic image of the document in one window, and another window with fields for typing the necessary data. This method is more expensive than keying from paper because of the additional step of scanning the paper documents. However, key-from-image methods of data capture can be more efficient than key-from-paper methods if compatible data entry programs are utilized. Operators can sometimes key faster from images since they do not have to remove their hands from the keyboard in order to view or handle paper documents. Operators also save time keying from images because operators are not required to leave the computer to pick up and return the paper documents to their supervisor.

Converting paper documents to electronic images is the first step in enabling recognition technologies in order to reduce manual keying. Using the recognition technologies method of data capture, information is captured by a keyless method, with the computer actually reading the paper document by using high-technology systems to identify and interpret the data. The several types of recognition technologies available today will be discussed later in this document, under the heading of “Automated Data Entry.”

Traditionally, using any of the three forms of data entry, data that has been captured is transmitted to a mainframe terminal, which is a device connected to a computer network that acts as a centralized point for information entry and retrieval for an organization. Using this traditional model, all keying has to be done “in house” on the mainframe or host system that is the repository for captured data.

More recently, service bureaus, which are independent companies that receive data from a client and enter and process that data in their own computers using their own labor have been enlisted as an alternative to the traditional mainframe model of data capture. The service bureau model can reduce the strain on a client's mainframe system and labor force, and can be an enormous help to businesses or government agencies who experience periods of inherent peaks in data processing. For example, mail order companies that do most of their business around the holiday season, or agencies that need to process tax returns which are mostly returned in March and April, require additional staff during those peak processing periods. Hiring a service bureau allows an organization to utilize economies of scale to meet the demands of their peak data capture and processing requirements at a lower cost through outsourcing of data entry projects. It also allows these organizations to avoid maintaining additional data entry facilities. Moreover, the service bureau method avoids excessive hiring of additional temporary staff, thereby avoiding the personnel management issues inherent in the hiring and maintenance of a temporary staff of less experienced data entry operators. Companies that hire a large temporary data entry work force may find that the temporary staff is susceptible to high turn over and reticent to work the less desirable second and third shifts.

While outsourcing the data entry to the service bureau has some advantages as illustrated above, it also has several drawbacks. First of all, the current service bureau model requires that sensitive documents be delivered to an external third party, which increases the risk of compromised data security. Documents can be lost or misplaced during transit to an external location, or the sensitive information contained in those documents can be misappropriated and misused by the service bureau, its employees, or other external individuals. Second, outsourcing can lead to data import and export issues. When a service bureau receives printed forms, it must then compile that paper data into a disk format which is readable by the customer's host computer. Much time can be wasted trying to organize the data into a suitable format, and accuracy can be compromised as a result of this process. In such a situation, in can be impossible to determine whether the paper form itself had inaccurate information, or whether data was lost or altered during creation of the appropriate disk format.

In addition, current methods for using a third party such as a service bureau result in a loss of control for the customer over the processing of data. Since service bureaus are external to the business process and are not integrated into their customer's process, inherent delays exist surrounding the use of that data. If control over the forms does not lie with the customer, it is extremely difficult to create management statistics, such as percent of forms keyed, keystrokes per hour, and rate of accuracy, all of which are useful in managing the overall production.

Automated Data Entry

As a result of the inherent inefficiencies associated with traditional data entry involving key-from paper and key-from image methods, an evolution has occurred to produce a more automated approach to data entry. Automated data entry is a method of data capture utilizing computerized recognition technologies (“recognition technologies”). Recognition technologies typically capture data by “reading” forms that are processed through optical image scanners (“scanning”). Optical image scanners are automated data capture hardware devices that read text and convert it into a digital code. The resulting digital code can be further processed by computers.

Because scanning of paper documents allows information to be captured in an electronic form, scanning can be used to facilitate key-from-image methods of data capture by operators. Key from image is preferred over key-from-paper methods because operators do not handle paper documents. However, key-from image methods can be significantly improved through use of scanning and recognition technologies to reduce the amount of information that needs to be keyed, or to verify the accuracy of keyed data.

There are three primary types of recognition technologies that are employed to enable optical image scanners (the “hardware”) to “read” the data that is scanned: 1) optical character recognition (OCR); 2) intelligent character recognition (ICR); and, 3) optical mark recognition (OMR). OCR is a technology that recognizes typed or machine-printed data from an image, and provides the ability to turn images of typed or machine-printed characters into machine-readable characters. By contrast, ICR is a technology that recognizes and interprets hand written data, which provides the ability to turn images of hand printed characters into machine-readable characters. Lastly, OMR is a technology that detects the absence or presence of a mark contained in a data field such as a box or small circle (sometimes referred to as “bubbles”) which is designed to be filled in by an applicant or respondent.

Recognition technologies have the potential to achieve considerable cost savings when compared to manual methods of data entry such as keying. While recognition technology is constantly improving, it is not yet at the point where it works flawlessly. Frequently, a character, field, or document cannot be accurately read by a recognition technology such as OCR, ICR or OMR. Such a character, field, or document is referred to herein as a “reject.” As a result, recognition technology includes software that is responsible to “flag” rejected items, and to require a data entry operator to visually inspect and validate the correct information from the image. Such data entry correction is referred to as “reject repair” data entry. An acceptable implementation of current recognition technology can be expected to be 85 to 90 percent accurate, resulting in 10 to 15 percent of all characters, fields, or documents being reviewed for reject repair by data entry personnel. Thus, while recognition technology appears to represent an improvement over traditional data entry methods, it is not necessarily the complete solution since it still requires data entry personnel to key reject repairs.

Furthermore, current automated data entry methods do not ensure that the recognized data is 100 percent accurate, since data entry personnel only are presented those characters or documents that are flagged by the software. Current recognition technologies do not address erroneously recognized characters (known as “substitution errors”) produced by the recognition technology. A typical method utilized to ensure that substitution errors are not introduced into the data set is to require data entry operators to manually key data to allow verification of all scanned characters, fields, or documents. Double key verification technology provides a reliable way to detect errors by comparing the data produced by the recognition technology against data keyed by a data entry operator. When double key verification is used in conjunction with recognition technologies, accuracy rates of more that 99.9 percent can be achieved.

Remote Data Capture and Entry

With the recent hi-tech advancements and the rapid growth of Internet technologies, software developers and users alike have been able to recognize the potential benefits that the Internet represents when incorporated into the business process. The creation of the Internet and its ever-increasing access by organizations and individuals means that a large global workforce has been created and is ready to be utilized. This workforce can be “employed” anywhere individuals can access the Internet, which means that individuals can work from almost anywhere, including their own homes.

As a result of its increasing availability and access, the Internet is beginning to be leveraged as a solution for many difficult and time-consuming computer and workforce problems. One such solution is data entry in the form of remote data capture. Remote data capture refers to any operation where the data entry is performed in a location separate from the main processing functions. By utilizing an image-based operation, data entry and verification can be performed anywhere that means for adequate inter-computer telecommunications (such as the Internet or a dedicated line) exist.

As a result of the Internet and related inter-computer telecommunications, labor-intensive computer operations such as data entry can be extended out to home workers or remote sites in low cost labor markets. For larger volumes of data to be entered and verified, the work can feasibly be outsourced to service bureaus that specialize in data entry operations. Currently, software exists which enables full scanned images of documents to be sent to remote data entry operators, who download or print a batch or group of scanned images and then perform data entry, data review, and editing operations. Once the remote operator keys the relevant data to create a data set, the freshly keyed or corrected data is sent back to the customer's mainframe and the scanned image is erased from the local memory of the remote data entry operator's computer and mainframe.

Although the current method of remote data capture may solve some customer problems involving data entry operator staffing, paper transit, and document control by utilizing an inter-computer telecommunications means such as the Internet to transport electronic images of documents, it does not solve the issue of data confidentiality since data is presented as a complete document to the remote workers. For example, if a data entry worker sees an entire image of a scanned document, it is very likely that sensitive information such as the social security number in conjunction with name will be readily viewed. In this instance the sensitive and confidential nature of the data is not adequately protected from misappropriation or misuse by remote keyers or other persons who may view the scanned image.

For all these reasons, there exists a continuing need for a system and method for efficient, accurate and secure data capture, data entry, and data verification. Moreover, there exists a need for secure data capture, data entry and data verification by remote users using global inter-computer telecommunications means such as the Internet.

In light of the shortcomings of the prior art, it would be particularly desirable to have a system and method by which questionable data appearing on individual forms could be divided or sub-divided into “snippets” of information, which could be securely sent out over an Intranet or Internet to be processed and verified by individual widely distributed end users or “keyers”.

It would also be desirable to provide a system and method by which data verification and resolution could be performed on a large variety of forms and documents, including tax forms, credit card applications, medical claims and any other form in which a hand written or machine printed item must be accurately read, identified, entered, and verified.

It would also be desirable to provide a system and method by which individual data entry personnel can sign up and be compensated for entering and verifying information via an Internet website or other secure inter-computer communication means.

It would further be desirable to provide a system and method whereby dual key data verification can be performed via a global computer network such as the Internet.

It would further be desirable to provide a system and method which facilitates the verification of data in a number of varying industries and applications, including but not limited to tax forms, credit card forms, banking forms, medical claims and benefits forms, and other applications which utilize forms to gather data.

It would also be desirable to provide a system and method by which entities desiring to implement a data entry system could input the form they desire to have entered and verified, and automatically employ the system.

It would further be desirable to provide a system and method which can be implemented via a commercially viable method, including but not limited to remuneration to keyers in the form of cash, products, discount and other branding and affiliate programs.

These and other objects of the present invention and features of the present invention will become apparent from the detailed description and from the following summary, detailed description and claims.

### SUMMARY OF THE INVENTION

The present invention is directed to a cost effective solution for addressing the above-described problems of data capture, data entry, and data verification and to a novel and unique system and method for effectuating remote data entry and verification over a global computer network such as the Internet or a dedicated network such as an intranet. The present invention allows organizations to outsource data entry and data verification and data repair needs, while maintaining security, accuracy and timeliness of the information processed. The invention is directed to a suite of computer software and hardware applications that collectively allow scanned documents containing unverified confidential or sensitive information to be read, broken down into smaller individual fields (“snippets”). The snippets are then scrambled for additional security before electronic dispatch via intercomputer telecommunication means to a secure remote server, and ultimately to remote end users such as data entry operators (“keyers”) for data entry and/or data verification and repair.

The present invention can be integrated with existing image-enabled data capture systems or any computer system that contains electronic document images. More specifically, the invention supports integration with key-from-image (KFI) as well as automated character recognition data capture systems utilizing ICR, OCR, or OMR technologies.

In one embodiment, remote “keyers” use a standard web browser on a modem-enabled computer to log into a particular website or web application. Once access to the website or web application is gained, the keyer is provided with a graphic user interface “GUI” which provides snippets of captured data for keying. The remote keyer keys the displayed snippet into a data entry field provided by the GUI. The keyed data is then transmitted back to the server for validation by comparison to corresponding data that was either identically keyed by another keyer, provided by a cross-reference, or provided by a character recognition technology.

In one embodiment, the invention facilitates pluralities of keyers who preferably register at a central Internet website by logging in from their own computers. In a preferred embodiment, each keyer is assigned a unique identifier such as a registration number or user name so that the identity of the keyer and the source of the keyer's keyed data remain traceable to the operator of the invention. Keyers who log on to the system are presented with a GUI that displays only randomly ordered data fields or snippets. In one embodiment, no two data fields or snippets from the same form, such as customer name and matching social security number, are ever provided to the same keyer. This embodiment ensures that no remote keyer ever gains enough information to either misuse data, or even to identify the type of document from which the data originated. After keying, entered data is sent back through the system, de-scrambled, and compared to another source for validating accuracy. In one embodiment, if two keyers enter and verify the data identically, the data is deemed to be validated. In another embodiment, if data from one keyer and available recognition technology results match exactly, the data is deemed to be validated. In still another embodiment, if comparison between one keyed entry and an available cross-reference (such as database table) match exactly, the data is deemed to be validated.

The invention provides an ideal solution for sensitive remote data entry due to its strict security features. As previously described, the present invention captures fields on each scanned form and divides the fields into smaller image snippets. The present invention then scrambles the snippets from multiple scanned forms and creates a key for unscrambling of the snippets for re-assembly of entered data after keying and verification of the corresponding data. The invention next divides and distributes the snippets among uniquely identifiable registered end users of the website or web application, ensuring that no remote keyer ever gains enough information to compromise security of the snippet source. As a means to guarantee the security and confidentiality, the invention allows for snippets to be tested “in house” before release for keying. Special note is taken to observe any potential compromise of security or confidentiality of the source form or document.

The present invention also provides a feature for rating the remote keyers. In a preferred embodiment, remote keyers are assigned a trust rating, which rating increases for each verified data field entered and decreases for each data field that is inaccurate. A remote keyer whose trust reading drops below a pre-determined rating threshold (assigned by the system or by the operator of the system) can be counseled, or can be automatically denied further access to the system. The pre-determined trust rating threshold can be raised or lowered depending on the level of security required by the client.

While the present invention may utilize image or data snippets comprising entire data fields, where appropriate, for example, with credit card numbers, the system can further break down extremely sensitive information into sub-fields so that an image snippet never displays the entire number to a single keyer.

As noted above, in order to ensure data verification accuracy, the present invention employs dual source verification. Each keyed snippet is confirmed by at least two independent sources. In one embodiment, each snippet is keyed in by at least two separate remote keyers. In another embodiment, each snippet is keyed by at least one remote keyer and is then verified against data entered using ICR/OCR/OMR recognition technologies. In still another embodiment, each snippet is keyed by at least one remote keyer and is then verified against a cross-reference such as an embedded table. Preferably, a cross-reference table will contain a list of all appropriate values which can be associated with a given data field.

In still another embodiment, each keyed snippet can be automatically verified without the need for entry by another remote keyer. In this embodiment, a keyed entry can be verified using data available from ICR/OCR/OMR recognition technologies and validated using an embedded cross-reference table. The invention contemplates all possible combinations of keying, recognition technology, and cross-reference tables to capture, enter, and verify remotely keyed data corresponding to data fields and snippets. In one embodiment, in order to ensure accuracy of remotely keyed entries, a scrambled snippet which is not verified upon comparison with the second data entry (whether created by another keyed entry, data from recognition technology or from data in a table) is re-distributed for keying until it is verified accurate. This means that at least two sources (for example, two keyers with a trust rating above the minimum threshold) have entered data that matches exactly. Keyed data is automatically discarded if a keyed answer contains any invalid characters. Thus, if a letter is typed in a field designated as the account number, the system discards the keyer's entry and sends the data out to be keyed again by another keyer.

The present invention also contains a number of specific features focused on improving processing speed and accuracy of keying. Registration fields, blank field detection, field types, and word parsing are such methods. Registration fields are used to ensure that keyers are not presented with snippets having poor image quality making the form indecipherable. If the system detects poor image quality, the snippet, or in some cases the entire scanned document, will not be sent to keyers for processing. Field types allow the system to classify the type of data expected in a field, and that classification is preferably communicated to the keyers. For example, if fields are coded as currency, then data entry personnel do not need to enter symbols such as “$”. If a field is coded as numeric, then data entry personnel can make use of the 10-keypad. Blank field detection ensures that those fields on a document that were left blank by the applicant are never sent to keyers for processing. Word parsing is provided to allow for the separation of multi-word fields into sub-fields. For example, instead of presenting the keyer with “1313 Mockingbird Lane,” one keyer would be presented with “1313”, a second keyer would be presented “Mockingbird” and a third keyer would be presented with “Lane”. As a result of word parsing, keyers are likely to make fewer mistakes, since each field is made up of a smaller number of characters.

One embodiment of the invention provides the capability for remote “keyers” to log into a particular website, www.keyforcash.com, which is accessible to anyone with Internet access, making the potential workforce limitless. Keyers may be employees of a customer or service bureau, or may be independent contractors, or any combination thereof. Companies utilizing independent contractors to staff the remote data entry workforce may benefit from the elimination of traditional employee benefits, management costs, and other employment costs. Keyers may be independent individuals or affiliates who participate or enter the system through affiliate websites. Keyers will typically work from their own homes, which may eliminate facilities costs.

In one embodiment of the invention, keyers are only paid for what they key correctly, so there is no concern that customers will pay for inaccurate data entry. For example, if the first keyer and the second keyer are not in agreement as to the data associated with a specific snippet, the snippet will be sent to a third keyer for validation. If in that instance the value that the third keyer enters agrees with the value of the second, only the second and third keyer are compensated.

Keyers, in one embodiment, will be able to view how long they have been keying (time online), the amount of money they have earned, and their current trust rating. The convenience of working from home on a flexible schedule means that clients who use the invention will have access to a large pool of data entry operators twenty-four hours a day without compromising security or accuracy. Having such a workforce constantly on call leads to data entry projects being completed in a timely manner. Keyers can log on to the web site 24 hours a day, 365 days a year. People can work evenings, weekends, and holidays—whenever their schedule permits. Since keyers are always ready to key, there is no wait to hire, or need to fire them when peak processing slows.

In accordance with the present invention a system for validating the accuracy of data on a form is disclosed. The invention comprises a control unit, which is defined herein as any image-enabled data capture system, including but not limited to an optical image scanner having an associated database. The control unit is used to input a form to be verified. A computer system is provided which is linked to the control unit and to a network server having a network database, which computer system comprises an application server, a database server, and supporting software for defining a plurality of data fields in the form to be verified such that each data field defines and corresponds to a unique data entry. The computer system extracts data entry to be entered and verified off of each form to create snippets, reversibly scrambles the snippets, and transmitting the snippets to the network server for distribution over a global network to remote keyers. Remote keyers use remote keying stations to enter and verify the data corresponding to each snippet before sending the data entry to the network server and computer system for comparison and acceptance of the data entry as valid. Data entry is valid if each remote keyer identically enters and verifies the data entry in conjunction with another source, such as recognition technology results, cross reference data, or another keyer's input.

In another embodiment, the invention is a method for entering and verifying data from a form comprising the steps of: defining a plurality of data fields on a form to be entered and verified; defining one or more unique data entries from each field to be entered and verified; extracting each unique data entry to form a snippet, reversibly scrambling said snippets to ensure confidentiality of the form; transmitting each scrambled snippet to remote keyers via a communication link to a global computer network, preferably such that each remote keyer is unaware of the existence of the other remote keyers; presenting snippets to end users using a graphic user interface, requesting that each end user correctly enter and verify data entry corresponding to each snippet presented; securely transmitting each entered and verified data entry back to the computer system; and accepting as valid each data entry which is entered and verified by at least one end user and confirmed as accurate against data entry from at least one other source.

### BRIEF DESCRIPTION OF THE FIGURES

FIG. 1 illustrates a block diagram of the system in accordance with the present invention.

FIG. 2 illustrates the creation of snippets in accordance with the present invention.

FIG. 3 illustrates the creation of sub-field snippets in accordance with the present invention.

FIG. 4 illustrates the creation of snakes in accordance with the present invention.

FIG. 5 illustrates a website based interface whereby remote keyers are presented with snippets of data to enter and verify.

FIG. 6 illustrates a website based interface showing remote keyer activity in accordance with the present invention.

FIG. 7 illustrates a website based interface showing payment of keyers in accordance with the present invention.

### DETAILED DESCRIPTION OF THE PREFERRED EMBODIMENT

The present invention is directed to a system for entering and verifying data entry using, in one embodiment, a global computer network such as the Internet. In particular, the present invention is directed to a system whereby remote data entry and verification from confidential forms and information can be performed and facilitated by multiple, remotely situated individuals, in a manner that maximizes confidentiality and security. In a commercial embodiment, the present invention may comprise an Internet website such as www.keyforcash.com whereby remote keyers may securely access the site, register, enter and verify data for remuneration or compensation. In such a system, remote keyers are asked to enter data, verify prior entries, and/or validate unclear or illegible data entries appearing on a graphical user interface.

The present invention is broadly directed to a computer network system for distributing confidential data gathered from forms such as tax forms, credit card applications, medical bills and the like which can then be entered, reviewed and verified by remote keyers in a matter which preserves a high level of confidentiality and security. The present invention is designed, in one embodiment, to be utilized on the World Wide Web or Internet, although the present invention is equally applicable to other network environments including wireless environments.

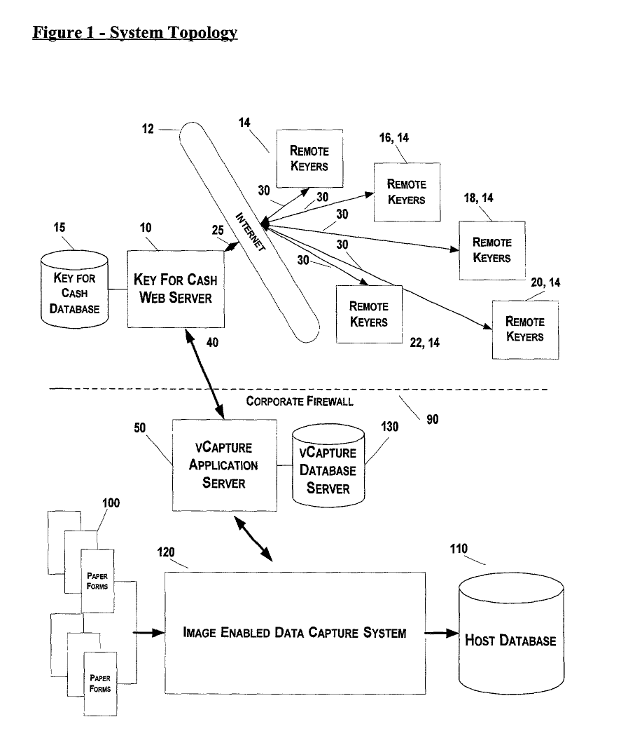

Referring to FIG. 1, a preferred embodiment of the present invention is disclosed and shown. The preferred embodiment comprises a Web HTTP computer server 10 and its associated database 15 and software that provides a portal to the remote keyers 14 via the Internet using standard HTTP access 25 via communications link (30). The Web HTTP server connects to an application server 50 and its associated database 15 using a secure communications link 40. In a preferred embodiment, remote keyer stations 14 comprise a plurality of remote keyers 16, 18, 20, 22. “Remote keyers” 16, 18, 20, 22 are defined herein as individuals linked to the system who will enter, review, and verify the accuracy of a data entry. In this embodiment, remote keyers are presented with a hand written or machine printed data snippet on a graphic user interface (“GUI”), and are instructed to “key” in what they see. Remote keyer stations 14 are linked with the central Web HTTP server 10 via a communication link 30. A separate computer system and software 50 will be utilized to create the snippets, as described in greater detail below.

Remote keyers 16, 18, 20, 22 will typically comprise individuals such as housewives, students, part-time workers, or general Internet users who, in a most preferred embodiment, will be linked via a communications link 30 to a global computer network such as the Internet or Worldwide web. Other embodiments may include local area networks (LANs), wide area network WANs and Intranets, and any other network may fulfill the spirit and scope of the present invention.

The remote keyer stations 14 may comprise any device that is capable of communication with the system. Devices include, but are not limited to, such devices as televisions, computers, hand-held devices, wireless electronic devices, and any device which uses a communications link 30. Non-limiting examples of a communications link 30 applicable for use in the present invention comprise any telecommunications or radio backbone or link such as an ATM link, FDDI link, satellite link, cable, twisted pair, fiber optic, the internet, the world wide web, LAN, WAN, or any other kind of internet or intranet environment such a standard Ethernet link. In each case, keyers will communicate with the system using protocols appropriate to the network to which that keyer is attached. All such embodiments and equivalents thereof are intended to be within the scope of the present invention.

Referring again to FIG. 1, the present invention may comprise a multi-Web server 10 and application server 50 environment which comprises a computer system in accordance with the present invention that allows the multiple remote keyers 16, 18, 20,22 to communicate with the system. Through a communication link 30, remote keyers 16, 18, 20, 22 will receive snippets for data entry and/or verification. Remote keyers are linked to the web server 10 preferably by a customizable graphic user interface (“GUI”) described in greater detail below.

Again referring to FIG. 1 the web server 10 routes signals through the system to the various servers, to be described below, and to and through transport medium 30 to remote keyers 16, 18, 20, 22. The application server 50 and its associated database server 15 may operate using a relational database server. The application server 50 further includes software and features to provide administrative capabilities and monitoring for the system. The administrative capabilities allow administrators or other operators to perform operations that affect the entire system. Such operations include, but are not limited to, administering the accounts of remote keyers 16, 18, 20, 22, monitoring the traffic through the system, tabulating of keyer activity, compensation, work-in-progress, balances and ratings, printing reports, updating access to new and existing remote keyers, performing of system backups, and maintaining the software programs and hardware that comprise the system. Preferably, the operators of the system may create, delete and update account information utilizing the administrative capabilities discussed above. A billing capability is preferably provided for crediting and debiting remote keyer accounts. As will be discussed below, remote keyers 16, 18, 20, 22 will typically receive remuneration of some manner for participating in the system such as cash.

The Web server 10 is responsible for all interactions with a web browser that is located in the remote keyer stations 14 and serves as the remote interface to the system. All interactions between the remote keyer stations 14 and the database subsystem occur through the HTTP web server 10. The expression of the user interface presented to remote keyers 16, 18, 20, 22 on their keyer stations 14 may be implemented as HTML or other high level computer language or technology known to those skilled in the art, and may be displayed in a standard web browser. Typically, the interface will be presented as a website presentation such as www.keyforcash.com.

In a most preferred embodiment, the Web server 10 is the end user's point of entry to the system. The system determines the identity of the remote keyers 16, 18, 20, 22 and makes appropriate decisions while serving web pages to the remote keyers 16, 18, 20, 22. The Web server acts as a transactional server 10 by sending HTML or other high level computer language to the remote keyer stations 14 validating passwords, sending logging and transaction information to the database server 50, and performing logical operations.

The system is protected from unauthorized access or manipulation by a “firewall” 90, an important precaution due to the sensitive and confidential nature of the information in the system of present invention.

In a preferred embodiment, the database 15 stores all pertinent administrative information pertaining to keyer accounts, administrator accounts, payment and remuneration parameters, as well as general dynamic system information. All interactions with the database 15 are performed through database-stored procedures. These procedures are used to implement high-level database functions, and to shield the details of the database implementation from the other components of the system.

For administrative purposes, an interface may be provided for operators and managers of the system. Such interface may be used to modify the database, print reports, view system data and log keyer comments and complaints, and to perform other administrative tasks know to those skilled in the art. The administrative portion of the system preferably provides a collection of access forms, queries, reports and modules to implement the administration interface. Administrators preferably will have the capability and authority within the system to force most actions. The administration portions of the system will interact with the communications, database and billing aspects of the system.

The administrative portions of the system will be used to contact remote keyers 16, 18, 20, 22. Remote keyers 16, 18, 20, 22 may be notified by phone, fax, email, pager, or other communications devices which are capable or contact by the system. In one embodiment, remote keyers 16, 18, 20, 22 will also have a password to access a website where they can access information relevant to their activities, and to view or generate detailed reports.

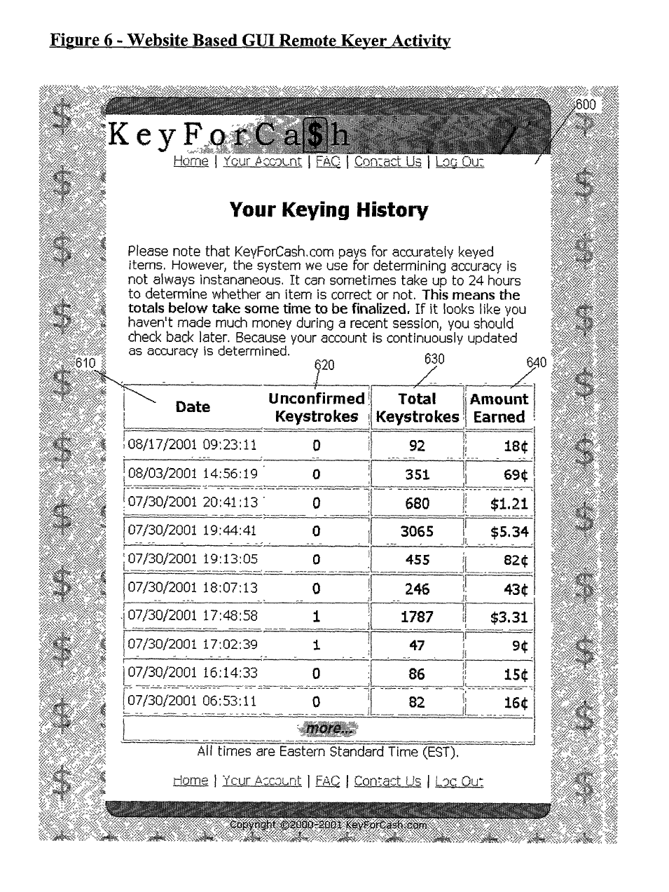

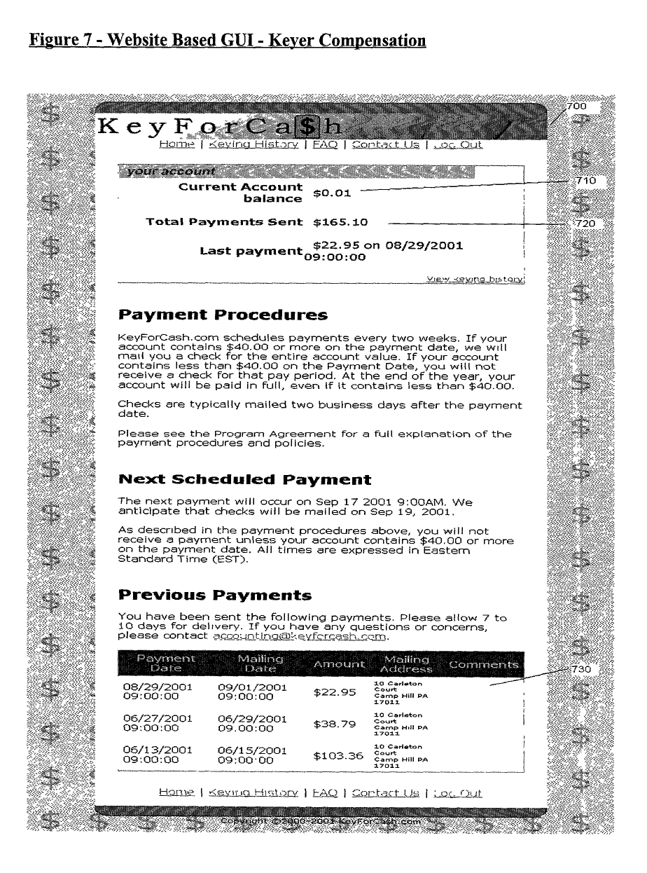

As shown in FIGS. 6 and 7, in one embodiment, the remote keyers 16, 18, 20,22 are provided with a printout of the amount of money they have earned based upon their keying activities. FIG. 6 illustrates a user web page containing a history of a keyers data entry and verification activities 600. The information is broken down by date 610, the number of keystrokes not yet verified 620, the number of total keystrokes 630 and the amount earned 640. FIG. 7 illustrates a user web page containing a keyers account information 700. This page indicates what current monies are still owed 710, total payments received to date 720, as well as a itemized breakdown of all payments sent 730 to the keyer.

Statistical calculations will be performed by the database servers 15, 130 along with other types of report generation. Preferably, the database servers can log directly to an Open Database Connectivity (ODBC) standard data source. This makes the availability of the data collected by the database servers concerning activity on the system more readily available and easier to process into logical reports.

In one embodiment, one or more operator workstations will be provided for administering the system. As the need for additional workstations arises, additional operator workstations can be added by adding additional computer systems, installing the administration software and connecting them to the LAN.

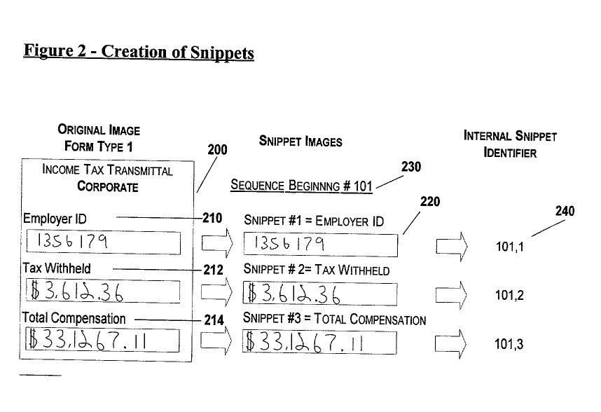

With the above background setting forth the operating environment of the present invention, referring now to FIGS. 2 to 7, the present invention is now more fully described. The invention is directed to a system, which in one embodiment, comprises an Internet application in which remote keyers 16, 18, 20, 22 may access the system, register and then enter, review, verify, and process data entry served to them in accordance with the present invention.

From the administrative and server side, the system comprises a suite of hardware and software applications which allow scanned documents contained in an Image enable data capture system 120, or from any location that has a collection of digital images, including images which have unclear or illegible sensitive information, to be broken into individual data fields or snippets. As noted herein, non-limiting examples of such documents 100 for the purposes of this disclosure comprise tax forms, credit card applications, medical claims, etc. As previously described, the term “snippet” refers to a predefined data element or portion of a predefined data element, such as a social security number, tax paid total or address. Snippets from different forms are preferably scrambled for additional security before transmitting to remote keyers for viewing data entry and data verification of the displayed snippet.

FIG. 2 illustrates a document 100 of the type that will be utilized in accordance with the present invention. As shown for illustrative purposes, the document may comprise a corporate income tax transmittal form that has a series of information hand written thereon. It is to be stressed that any form or document, including but not limited to federal, state or local government forms can be used in the present invention, As shown, the illustrative example includes data in the form of the employer ID 210, the amount of compensation paid to the taxpayer's employees 214, and the amount of monies withheld from the taxpayer's employees 212. It is to appreciate that additional information such as the address and phone number of the taxpayer can also be included, but the example has been simplified for illustrative purposes. In short, the teachings of the present invention are applicable to forms having any number of data fields.

Referring to FIG. 2, the computer system and method of the present invention is now described in detail. The computer system will comprise a series of hardware and software application modules 50 that will permit documents to be defined, divided into data fields, and data snippets to be extracted for data entry and verification by remote keyers. As shown in FIG. 2, each individual document is given a sequence number (e.g. 101,102, 103) 230. Thus, if there are 200,000 documents to be entered, the sequence may run from 1 to 200,000. Different documents may have different number sequences. For example, State tax forms may have a number sequence beginning at 101, et seq.

Each data point to be verified on each document is also given a numeric value (1, 2, 3) 220. For example, in the form of FIG. 2, the Employer ID is snippet one 210, the tax withheld is snippet two 212 and the total compensation is snippet three 214. Thus, in this embodiment, all of the data points on each form can be identified by a binary sequence of x, y where x is the sequence number of the form and y is the snippet of data to be verified on that form. This sequence becomes the Internal Snippet Identifier 240 in the system.

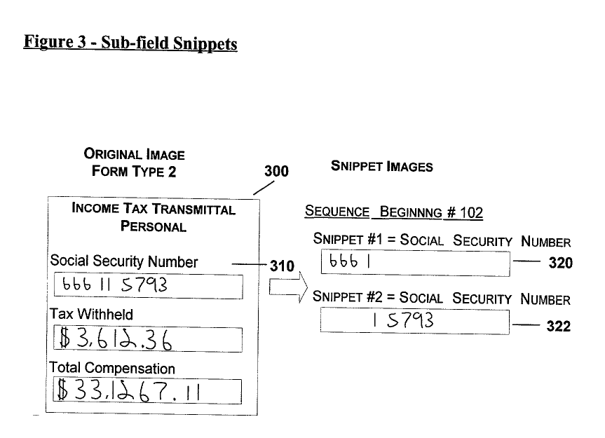

FIG. 3 illustrates an example document of the type that will be utilized in accordance with the present invention. As shown for illustrative purposes, the document comprises a personal income tax transmittal form 300 that will typically have a series of information hand written thereon. As shown, the illustrative example includes the social security number 310, the amount of compensation paid to the employee 314, and the amount of monies withheld from the employee 312. In this instance the data point associated with the social security number 310 is classified as sensitive information and needs to be broken down into sub-fields so that the entire number is never fully seen by remote keyers. Each sub-fields snippet is given a unique number 320, 322 illustrating its position on the document, and the system enforces that no single person will key both sub-field snippets from any given form. In a preferred embodiment, the system can ensure that no keyer is presented with more than one snippet from any document that has secure fields.

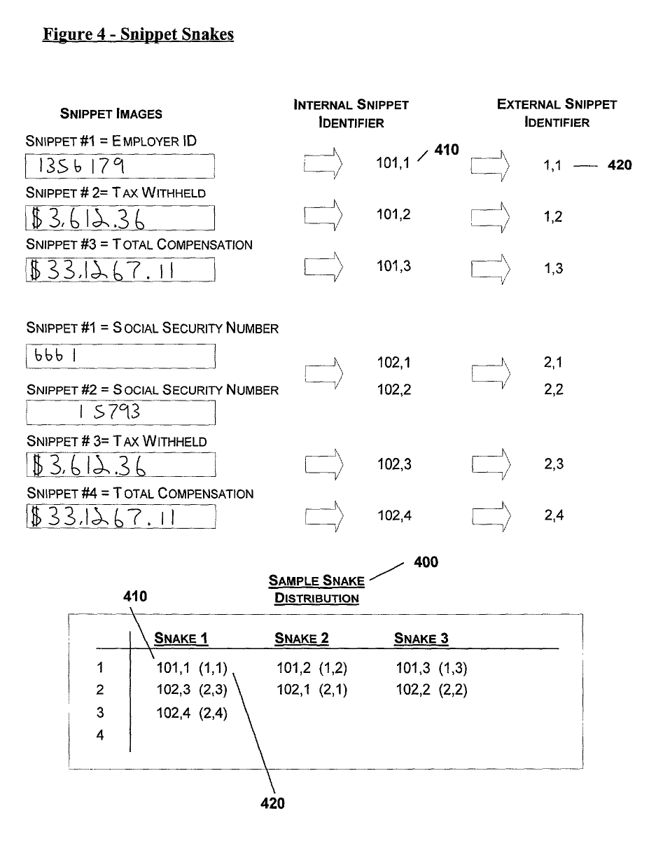

As shown in FIG. 4, the data snippets are then pre-stored in columns, referred hereinafter as “snakes” 400. The number of snakes are calculated based upon the level of security desired by the customer. Hence, if the customer desires that no remote keyer ever views more than one snippet of information, the number of snakes must equal the number of snippets to be checked. As shown in FIG. 4, three snakes are shown and each data snippet is divided between the three snakes.

As shown in FIG. 4, the present invention provides a further security mechanism. Within the application server 50 and other components behind the firewall 90 of the system, a snippet will be internally defined as described above by the Internal Snippet Identifier, and also by its position on the snake. Hence, snippet 101,1 is located on snake 1, position 1. Thus all of the information on each document can be identified by a binary sequence of x, y where x is the sequence number of the form and y is the snippet of data to be verified on that form. This creates a second binary indicator 1,1 410, referred to as the “External Snippet Identifier” External Snippet Identifier is the only number that is sent external to the system as part of the data header. In short, in one embodiment, two remote keyers 16, 18 will receive item 1,1. Remote keyers 16, 18 will be at different remote keyer stations 14 or will be otherwise geographically separated, and therefore will have no direct knowledge of each others existence. The remote keyers 16, 18 can therefore never collaborate to identify the document from which the snippet originated. The snippets are next scrambled for additional security, and dispatched across the firewall 90 via a secure communications link (40) to remote keyers.

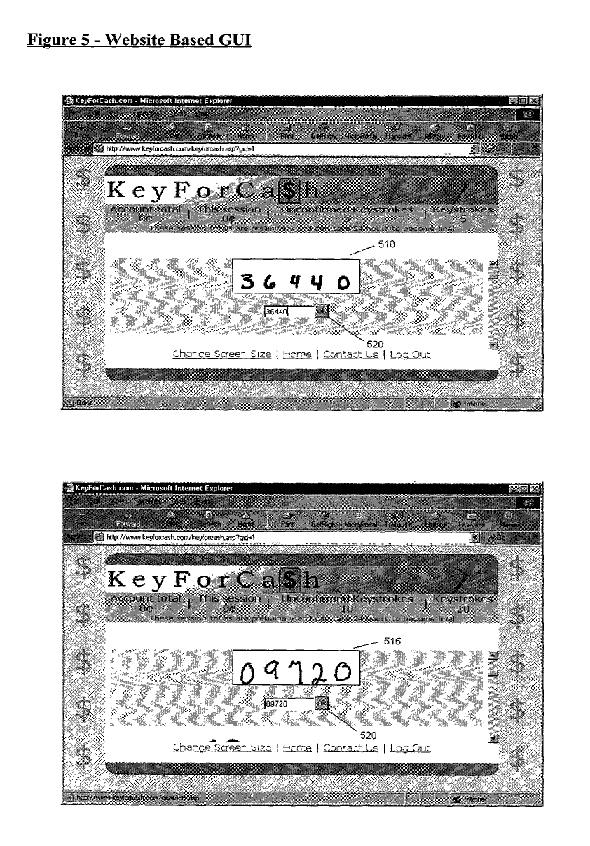

FIG. 5 illustrates a graphic user interface (“GUI”) in the form of a web page containing data to be keyed and verified. Remote keyers 16, 18, 20, 22 log into a website server via a standard web browser and are presented with a series of snippets. The remote keyers are asked to type in the data appearing in each displayed snippet. As shown in FIG. 5, the hand written value 36440 510 may be any value associated with one particular document and the hand written value 09720 515 may be part of another entirely different document. The remote keyer has no knowledge of the source or type of document associated with each snippet. The keyer then enters data which corresponds to the snippet and presses enter on the keyboard or the “OK” button 520 displayed on the GUI. Each remote keyer 16, 18, 20, 22 who is asked to enter and verify the snippet will only know that it is a hand written or machine printed snippet item taken from some form associated with the system. The identical snippet is sent to a second keyer for entry and verification. Alternatively, the data is verified by comparison to data from automated data capture such as cross-reference tables or the ICR/OCR recognition data.

The keyers 16, 18, 20, 22 see only randomly ordered snippet fields on the GUI. In the most secure embodiment, scrambling of snippets ensures that no two pieces of information from the same form (such as an account number and matching name) will be dispatched to the same keyer. After keying, data is sent back to the application server so through the web server 10 computer system. The header associated with the data is used to match each External Snippet Identifier to the Internal Snippet Identifier, and to update the database with the entered and verified data entry.

As discussed above FIG. 3 illustrates how the system can further break down extremely sensitive information fields such as the employer account number, into sub-fields so that the entire account number is never seen by a single keyer. The invention further incorporates a system that evaluates remote keyers. In one embodiment, keyers are assigned a “trust rating” which increases for each snippet which is keyed and verified as accurate, and decreases for each incorrectly entered snippet . A keyer with a trust rating below a threshold assigned by the system or system administrator for the system or for a particular set of forms will not be allowed to enter information into the system. The threshold trust rating can be raised or lowered by system administrators depending on the level of security required for a set of forms, and to allow flexibility in control over the expected accuracy of the data entered.

In order to ensure data accuracies, the present technology employs a dual key verification system. As noted, each snippet is entered and verified in by at least two separate sources; two separate keyers; one keyer and cross-reference data; one keyer and ICR/OCR recognition data; or cross-reference data and ICR/OCR recognition data. Each snippet is repeatedly keyed until at least two sources have keyed or recognized the information exactly the same way. Data entered from snippets is automatically discarded if a keyed or recognized snippet contains any invalid characters. Thus, if a letter is typed in a field designated as a number, the system discards the data entry and sends the snippet out to be keyed or recognized again.

The present invention also contains a number of specific features focused on improving processing speed and accuracy. Registration fields, blank field detection, field types, and word parsing are methods are recognized by those skilled in the art. Registration fields are used in the present invention to ensure that keyers are not presented snippets with poor image quality or which are illegible. If the system detects poor image quality, no field from the document will be sent to keyers for processing. Field types allow the system to classify the type of data expected in a field. Preferably, that classification is communicated to the keyers. For example, if fields are coded as currency, then data entry personnel do not need to enter symbols such as “$”. If a field is coded as numeric, then data entry personnel can make use of the numbered buttons on their device keypad. Blank field detection ensures that fields having no data present are never sent to keyers for processing. Word parsing allows for the separation of multi-word fields into sub-fields. For example, instead of presenting the keyer with the snippet “1313 Mockingbird Lane,” one keyer would be presented with “1313”, a second keyer would be presented “Mockingbird” and a third keyer would be presented with “Lane”. As a result, keyers will enter fewer mistakes, since each field is made up of a smaller number of characters.

The present invention further facilitates a wide variety of promotional applications and systems for facilitating the use of the system by remote keyers. As can be readily seen, the present invention is amenable to commercial, public, and private applications. In the embodiment of FIGS. 6 and 7, which exemplify the website www.keyforcash.com, remote keyers receive cash remuneration for correctly keying in snippets presented by a GUI. It is to be further appreciated that the teachings of the present application are applicable to a number of business models. For example, end user keyers may be individuals who seek coupons, frequent flyer miles, long distance telephone credits, or other premiums. For example, an internet service provider, utilizing the present invention, may contract with a credit card company. In consideration for remuneration, end user customers of the Internet Service Provider may get coupons or long distance service for keying in credit card application data. Similar models are contemplated by the present invention, including co-branding and affiliate relationships.

In addition, it is to be expressly understood that while the present invention is illustrated and described in the context of a tax form verification system, it is clearly amenable to any type of document or form in which hand written or machine printed data or information must be entered and/or verified. Without limiting the scope of the invention, the present invention are applicable to credit applications, mortgage applications, medical claims, insurance forms, utility bills, and almost every other imaginable standardized form or document. It is to be appreciated and emphasized that the system set forth herein is independent of computer operating systems and will work equally well in a wireless environment such as those embodied by wireless internet phones, and PDA (personal digital assistant) devices.

Lastly, the present invention can also be used for remote data entry from snippets captured from captured audio and video signals. In such embodiments, the system of the present invention captures data from an audio or video source, defines a field from the audio or video source, creates snippets, and present the snippets to remote users in aural or visual form on remote keyer stations for data entry and verification, or for narration of observed events described in such snippets. Remote users then key the aural or visual information (i.e. key what you hear or key what you see), and transmit the keyed information back to the computer system for verification and analysis. The audio embodiment can be used to create transcripts from dictated language (including but not limited to office memos, medical transcripts, depositions, and court hearings). The video embodiment can be used to create transcripts or narration of videotaped events (including but not limited to video surveillance, security tapes, and the like).

The present invention is described with reference to the above-discussed preferred embodiments. It is to be recognized that other embodiments fulfill the spirit and scope of the present invention and that the true nature and scope of the present invention is to be determined with reference to the claims attached hereto.

I claim:

1. A system for entering and verifying the accuracy of data from a document comprising:
a control unit for inputting a document;
a computer system connected to said control unit, said computer system comprising an application server and a database server, and having software means for defining a plurality of data fields from the document such that each data field defines and corresponds to at least one unique data entry and for reversibly scrambling said unique data entry;
a network server linked to the computer system by a first communication link:
means for securely transmitting said unique data entry from the network server an end user;
means for entering and verifying each unique data entry said end user;
means for securely receiving back each entered and verified unique data entry from said end user; and
means for ensuring the accuracy of each unique data entry entered and verified by said end user, and for accepting said data entry as valid if accurate.

2. The system of claim 1, wherein said first communication link comprises a firewall.

3. The system of claim 1, wherein said software means for reversibly scrambling the unique data entry comprises software which scrambles the unique data entry from several documents, and assigns and attaches one or more unique identifiers to each unique data entry.

4. The system of claim 1, wherein said means for securely transmitting scrambled unique data entry from said network server to said end user comprises a second communication link to a global network.

5. The system of claim 4, wherein said global network is the Internet, a Local Area Network, or a Wide Area Network.

6. The system of claim 1, wherein said means for entering and verifying each unique data entry comprises one or more remote keying stations linked to a global network by one or more communication links.

7. The system of claim 1, wherein said means for ensuring the accuracy of data entered and verified by said end user comprises software which transmits said unique data entry to at least one different end user for entry and verification and accepts said data entry as accurate if at least two end users enter and verifiy the data entry identically.

8. The system of claim 1, wherein said means for ensuring the accuracy of data entered and verified by said end user comprises software which compares data entry entered by said end user to data captured by recognition technologies.

9. The system of claim 1, wherein said means for ensuring the accuracy of data keyed and verified by said end user comprises software which compares data entry entered by said end user to data from a cross reference table.

10. The system of claim 1, further comprising means for compensating said end user for the correct entry and verification of said data entry.

11. A system for entering and verifying the accuracy of data from a form comprising:
a control unit for inputting information from a document to be verified and defining a plurality of data fields from the document such that each data field defines and corresponds to at least one unique data entry;
a computer system comprising an application server and a database server, said computer system connected to said control unit, said computer system having software which reversibly scrambles the unique data entry from the form and assigns and attaches one or more unique identifiers to each unique data entry;
a network server linked to said computer system by a secure communication link;
a global network linked to said network server for securely transmitting scrambled unique data entry to an end user;
at least one remote keying station linked to said global network by one or more communication links; and
network server and computer system software which receives data entered by said end user, compares the data entry to data entry from at least one different data entry source, and accepts the data entry as accurate if at least two data entry sources enter and verifiy the data entry identically.

12. The system of claim 11, wherein said global network is wherein the global network is the Internet, a Local Area Network, or a Wide Area Network.

13. The system of claim 11, further comprising means for compensating said end user for correctly entering and verifying each data entry.

14. A method for entering data and verifying the accuracy of data from a form comprising:
inputting a form using a control unit;
defining a plurality of data fields on the form to be entered and verified;
defining one or more unique data entries from each data field to be entered and verified;
extracting each unique data entry to create a snippet;
reversibly scrambling said snippet to ensure confidentiality of the form;
transmitting said snippet to an end user via a communication link to a global computer network;
using a graphic user interface to present said snippet to said end user to allow said end user to correctly enter and verify data entry corresponding to said snippet;
receiving said entered and verified data entry from said end user; and
accepting as valid said entered and verified data entry if confirmed as accurate against data entry from at least one other source.

15. The method of claim 14, wherein said end user receives remuneration for correctly entering and verifying each data entry.

16. The method of claim 14, wherein the step of defining one or more unique data entries from each data field further comprises dividing data fields into sub-fields so that no single unique data entry or snippet represents the entire data field.

17. The method of claim 14, further comprising the step of randomly ordering said data fields so that no two snippets corresponding to said data fields from the same form are ever dispatched to the same end user.

18. The method of claim 14, further comprising the step of administering access by individual remote end users based upon the individual end user's performance.

19. The method of claim 14, further comprising the step of improving data entry efficiency and accuracy by end users by ensuring that indecipherable fields are never presented to remote end users.

20. The method of claim 14, further comprising the steps of ensuring that end users are aware of the type of data which is expected to be entered for a given field.

21. The method of claim 14, wherein the global computer network is the Internet, a Local Area Network, or a Wide Area Network.

22. The method of claim 14, wherein said end user is a remote end user.
